(19) United States
(12) Patent Application Publication
(10) Pub. No.: US 2021/0233092 A1
(43) Pub. Date: Jul. 29, 2021

(54) SYSTEM FOR ASSISTING USERS WITH IDENTIFYING SERVICE PROVIDERS

(71) Applicant: Sarah Biggerstaff, Austin, TX (US)

(72) Inventor: Sarah Biggerstaff, Austin, TX (US)

(21) Appl. No.: 17/248,463

(22) Filed: Jan. 26, 2021

Related U.S. Application Data
(60) Provisional application No. 62/967,279, filed on Jan. 29, 2020.

(51) Int. Cl. G06Q 30/00; G06Q 30/02; G06Q 30/06; G06Q 50/00; G06Q 50/16

(52) U.S. Cl. CPC G06Q 30/0185; G06Q 30/0201; G06Q 50/16; G06Q 50/01; G06Q 30/0609

(57) ABSTRACT

Techniques are described for a networking system to provide validated reviews of service providers. In some cases, the networking system may include different classes or tiers of user. In some implementations, only users that are licensed with a board may be able to review, comment, or rate the service providers.

### CROSS-REFERENCE TO RELATED APPLICATION

This application claims priority to U.S. Provisional Application No. 62/967,279, filed on Jan. 29, 2020 and entitled “SYSTEM FOR ASSISTING USERS WITH IDENTIFYING SERVICE PROVIDERS,” the entirety of which is incorporated herein by reference.

### BACKGROUND

Social networking systems and platforms provide users with functionality to share images, content, and reviews associated with service providers with each other. In some cases, the posts may be used by a user to identify and select service providers for various projects. However, these posts are often piece meal, lack any indication of authenticity, and are often contradictory, which unfortunately, often increases the difficulty for the user with respect to selecting and vetting of service providers.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a view of an example platform for assisting real estate professionals with vetting and selecting service providers, according to some implementations.

FIG. 2 is a flow diagram illustrating an example process associated with registering real estate professionals and service providers with a platform according to some implementations.

FIG. 3 is a flow diagram illustrating an example process associated with ranking service providers according to some implementations.

FIG. 4 is an example platform that may implement the techniques described herein according to some implementations.

FIG. 5 is an example interface associated with searching for a service provider according to some implementations.

FIG. 6 is another example interface associated with searching for a service provider according to some implementations.

FIG. 7 is an example interface associated with the platform recommending service providers for a particular type of service according to some implementations.

FIG. 8 is an example interface associated with a service provider according to some implementations.

FIG. 9 is another example interface associated with a service provider according to some implementations.

FIG. 10 is another example interface associated with a service provider according to some implementations.

FIG. 11 is another example interface associated with a service provider according to some implementations.

FIG. 12 is another example interface associated with a service provider according to some implementations.

FIG. 13 is an example chat interface associated with the platform according to some implementations.

FIG. 14 is an example interface illustrating promotions associated with a service provider according to some implementations.

FIG. 15 is another example interface illustrating promotions associated with a service provider according to some implementations.

FIG. 16 is an example interface illustrating reviews associated with a service provider according to some implementations.

FIG. 17 is an example interface illustrating capturing rating data or review data associated with a service provider according to some implementations.

FIG. 18 is another example interface illustrating capturing rating data or review data associated with a service provider according to some implementations.

FIG. 19 is another example interface associated with the platform recommending service providers for a particular type of service according to some implementations.

FIG. 20 is another example interface associated with the platform recommending service providers for a particular type of service according to some implementations.

FIG. 21 is another example interface associated with a list of real estate professionals associated with a service provider according to some implementations.

FIG. 22 is another example interface illustrating review data associated with a service provider according to some implementations.

FIG. 23 is another example interface associated with a service provider according to some implementations.

FIG. 24 is another example interface associated with a service provider according to some implementations.

FIG. 25 is another example interface associated with a service provider according to some implementations.

FIG. 26 is another example interface associated with a service provider according to some implementations.

### DETAILED DESCRIPTION

Social networking systems and websites are often used to promote products and services. However, many of the conventional systems are directed to assisting the sellers or service providers in obtaining business and, thereby, generating advertisement revenue for the platform rather than actually assisting the user in obtaining quality goods and services. For example, conventional systems may utilize posts and/or reviews from other users to rate, rank, or otherwise vet the seller or service provider. However, these conventional systems typically lack any technique or ability to validate the content of the post or the user that provided the content other than merely requiring the originating user to be a member of the platform.

The social networking system, discussed herein, provides users with the ability to identify, select, and otherwise vet service providers, particularly home improvement and repair providers. For example, the social networking system may limit or otherwise restrict access to the platform to individuals having a real estate license or credentials. For example, upon registration the system may require the uploading or verification of a license or credential from a real estate board or the like.

Once verified, the system may allow the user to invite, promote, review, criticize, or otherwise evaluate various sellers and service providers with respect to the system. For example, only sellers that have been invited by a predetermined number of users (e.g., one user, two users, three users, etc.) may access the system. The system may also remove or restrict access to sellers that have received more than a threshold number of poor reviews, criticism, or removal request from the users. For instance, if a seller receives more than three one star ratings or negative comments, the system may remove the seller or otherwise restrict access.

In some cases, the system may limit the number of sellers or service providers per category and/or geographic region. For example, the system may only provide information related to a threshold number (e.g., three, five, ten, etc.) of service providers within a defined geographic region (such as a town, city, predefined distance of a landmark, etc.) for each category. In this manner, the highest ranking or highest rated service providers or sellers for each category are promoted by the platform. Further, as only credentialed or certified real estate professionals are allowed to review, recommend, and criticize the service providers, the system ensure that the reviews and comments have merit as the community of user's is small and peer review may occur.

In some implementations, only the verified users and the service providers or sellers may have access to the platform. However, in some implementations, additional users, such as homeowners, may be provided with access to the platform. For example, a homebuyer may be granted limited time access to review the service providers by a real estate professional after buying a home. In this manner, the homebuyer may identify service providers to remodel, update, or otherwise repair the newly purchased home. In other implementations, homeowners may be able to sign up at any time. However, in these implementations, the homeowners may be restricted from rating or evaluating the service providers and may only be able to view the available seller information. In this manner, the integrity of the review and vetting process of the service providers may be limited to or maintained with the real estate professionals.

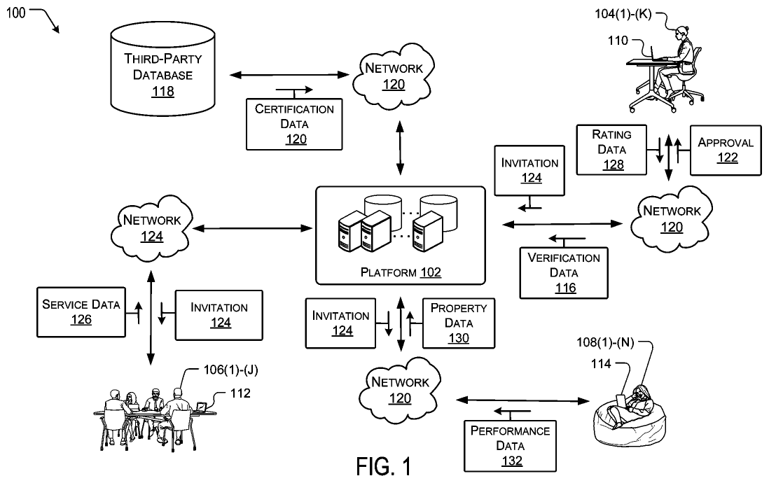

FIG. 1 is a view of an example social networking system for assisting real estate professionals with evaluating and selecting service providers, according to some implementations. In some examples, the system 100 may include a platform 102 that is provided or accessible as a cloud-based service. The cloud-based services may generally refer to a network accessible platform, such as platform 102, implemented as a computing infrastructure of processors, storage, software, data access, and so forth that is maintained and accessible via a network such as the Internet. The cloud-based services do not require end-user knowledge of the physical location and configuration of the system that delivers the services. Common expressions associated with cloud services include “on-demand computing,” “software as a service (SaaS),” “platform computing,” “network accessible platform” and so forth.

In the current example, the platform 102 may be accessible to various users. For example, the users may include real estate professionals 104(1)-(K), service providers 106(1)-(J), and, in some implementations, homeowners or general users 108(1)-(N). Each class of users 104, 106, and 108 may access the platform using various electronic devices, such as devices 110, 112, and 114. It should be understood that the electronic devices 110, 112, and 114 may take various forms, such as notebook or desktop computers, tablets, smart phones, and the like. In some cases, the devices 110, 112, and 114 may be equipped or otherwise host an application associated with the social networking system 100 to allow the users 104-108 to access and interact with the platform 102.

The real estate professionals 104 may initially, during activation or sign up with the platform 102, provide verification data 116 as well as general demographic and identification data to the platform 102. In some cases, the platform 102 may verify or confirm the verification data 116 with a third-party database 118. For example, the platform 102 may receive or access certification data 120 (120 is used twice in the pdf as Certification Data and as Network) accessible via the third-party database 118, such as a database maintained by a board of realtors. If the platform 102 is able to validate the verification data 116 with the certification data 120, the platform 102 may provide the real estate professional 104 with an approval notification 122 and allow the real estate professional 104 access to the platform 102. Otherwise, the platform 102 may request the real estate professional 104 reapply for access.

Once approved as a user of the platform 102, the real estate professional 104 may generate invitations 124 for either service providers 106 and/or general users 108. In some cases, the invitations 124 may be received and accepted by the service providers 106 and/or the user 108. In some cases, once a service provider 106 has been invited to the platform 102, the service provider 106 may be able to provide service data 126, such as service descriptions, images, videos, and the like of service provided, to the platform 102. The service data 126 may then be made available for access and viewing via the platform 102.

In addition to inviting service providers 106 to the platform 102, the real estate professionals 104 may be able to provide rating data 128 associated with various service providers 106. The rating data 128 may include reviews, criticism, star ratings, binary ratings (such as thumbs up and down), work product evaluations, and the like. The platform 102 may utilize the rating data 128 to rank or otherwise select service providers 106 for recommendation. For example, the platform 102 may rank the service providers 106 based on a geographic radius, city, town, etc. The platform 102 may then recommend the top predetermined number (e.g., one, three, five, etc.) of service providers 106. In this manner, as the platform 102 ranks the service providers 106 based on the rating data 128 provided from the real estate professionals 104, the platform 106 may provide a more trustworthy rating than other social networks that do not otherwise limit reviews and comments to a particular trusted class of users, such as the real estate professionals 104.

In some cases, the platform 102 may weight the rating data 128 when ranking the service providers 106. For example, the platform 102 may more highly weight negative feedback than positive feedback. Thus, a single poor review may be more likely to influence the ranking than multiple positive reviews. In this manner, the platform 102 may encourage more proactive and quality service by the recommended service providers 106. In some cases, platform 102 may also weight the rating data 128 based on an interaction level associated with the real estate professional (e.g., the more active the professional is with the platform the higher the weight applied to the corresponding rating data 128), demographic data associated with the associated real estate professional (e.g., years of experience, number of property sales, interactions with the credentialing board, such as more involvement with the board of realtors, ratings or disciplinary actions associated with the credentialing board, and the like), client reviews of the real estate professional 104 accessible via third-party sources, and the like.

In some cases, the users 108 may also receive an invitation 124 from one or more of the real estate professionals 104. For instance, the user 104 may be client of the real estate professional 104 and may have recently purchased a new property or residence. In some case, the user 108 may provide property data 130 associated with one or more assets of the user 108, such as a recently purchased home. The property data 130 may include an address, age, maintenance requests, prior work, and the like.

The user 108 may be able to access information, reviews, and other data associated with the service providers via the platform 102. In these cases, the platform 102 may present the top ranking service providers 106 within a geographic distance of the address provided by the user 108, as discussed above. The user 108 may then either contact or engage with the service providers 106 via the platform 102 or via an external source, such as a telephone network.

In some cases, the platform 102 may be configured to process a transaction between the user 108 and the service provider 106, such that the user 108 may file complaints or receive a refund upon a failure with respect to the services provided. In this manner, the user 108 may feel more comfortable with engaging with independent and/or smaller service providers 106 recommended by the platform 106. Additionally, the platform 106 may allow the users 108 to provide performance data 132 associated with the services provided by the service provider 106. As noted above, the platform 102 may rank the service providers 106 based on the rating data 128 provided by the real estate professionals 104. However, in some implementations, the platform 102 may accept performance data 132 from general users 108 when the platform assisted in the transaction of the services (e.g., a confirmed customer of the service provider 106). In these implementations, the platform 102 may weight the performance data 132, such as the performance data 132 affects a service providers rating (either positively or negatively) by a fraction (e.g., 25%, 50%, 75%, etc.) of the rating data 128 associated with the real estate professionals. In other cases, the platform 102 may only allow negative feedback within the performance data 132 to affect the corresponding service provider's ranking.

In some specific examples, the platform 102 may require a corresponding real estate professional 104 to confirm that the providing user 108 is a client and/or that the performance data 132 is accurate prior to the performance data 132 impacting the ranking of the service provider 106. In these examples, the integratory of the ranking may be maintained while allowing an additional voice to other users (e.g., property owners) of the platform 102.

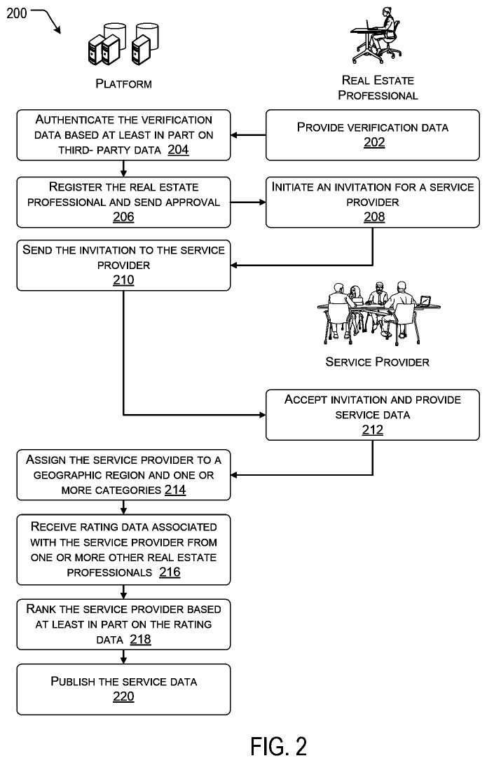

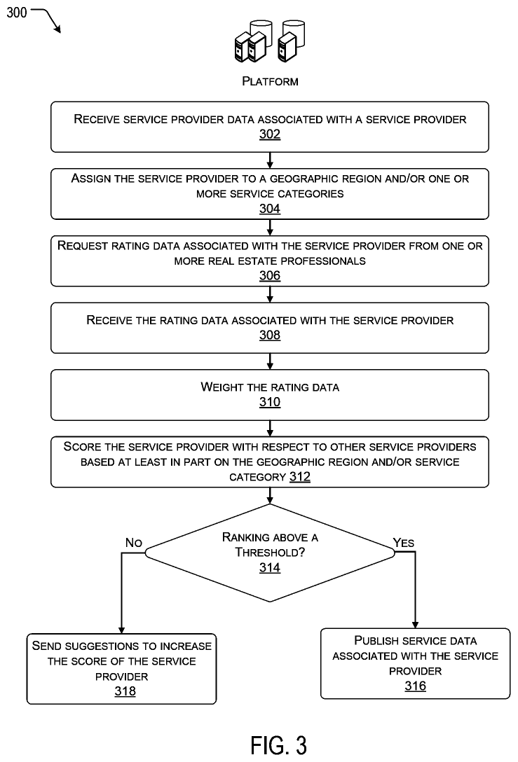

FIGS. 2-3 are flow diagrams illustrating example processes associated with the platform discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 associated with registering real estate professionals and service providers with a platform according to some implementations. As discussed above, real estate professionals may register with the platform and in some cases, invite or otherwise allow service providers to also register with the platform.

At 202, the real estate professional may provide verification data to the platform. The verification data may include credentials, such as a license or license number with one or more boards or authorities. For example, the verification data may include a real estate license with an appropriate board of realtors for the geographic region or jurisdiction associated with the professional.

At 204, the platform may authenticate the verification data based at least in part on third-party data. For example, the platform may compare the authentication data with an accessible database of licensed realtors or the like.

At 206, the platform may register the real estate professional and send an approval notification. For example, the platform may send a link that allows the real estate professional to enter demographic data, user account data, and the like in order to create an account and login with the platform. In other examples, the platform may send a registration notification allowing the user to login or access the platform.

At 208, the real estate professional may initiate an invitation for a service provider to access the platform. For example, the real estate professional may be allowed to invite a predetermined number of service providers per time period (e.g., such as month, quarter, year, etc.). In some implementations, the real estate professional may also invite other users, such as clients, to the platform. The invitations may include information or data associated with the service provider, such as contact information, number of joint projects, one or more ratings, a review or recommendation, services offered and services engaged, and the like.

At 210, the platform may send the invention to the service provider. In some cases, the platform may first check the service provider against a list of registered providers and/or excluded/blocked providers. Then, if the service provider is not either registered or blocked, the platform may send the invitation to the service provider.

At 212, the service provider may accept the invitation and provide service data. The service data may include information related to the services offered, recommendations, past project examples, address or service region, and the like.

At 214, the platform may assign the service provider to a geographic region and one or more categories. For example, the platform may assign the service provider to a geographic region based on the address provided by the service provider, based on a service region indicated by the service provider, based on jurisdiction or boundary associated with a corresponding town or city, based on a region associated with the inviting real estate professional, or the like.

The platform may also assign the service provider into one or more categories of service. For example, if the services listed by the service provider in the service data or in the initial information received from the inviting real estate professional are associated with plumbing services, the platform may assign the service provider to the plumbing service category. In some cases, the service provider may be assigned two or more categories, such as electrical and lighting.

In some examples, the categories may also include sub-categories that the service provider may be assigned. For example, plumbing category may include bathrooms and kitchens as two separate sub-categories.

At 216, the platform may receive rating data associated with the service provider for one or more other real estate professionals. In some cases, the platform may request the rating data from the real estate professional in the region assigned to the service provider. In other cases, the platform may notify the real estate professionals as to the fact that the service provider has or is being considered for registration with the platform. In some cases, the rating data may include reviews, comments, star ratings, binary ratings, and the like provided by the real estate professionals with respect to the service provider.

At 218, the platform may rank the service provider based at least in part on the rating data. For example, the platform may weight the rating data based on various factors, such as experience or trust level of the real estate professional, and then assign a score to the service provided based at least in part on the weighted ratings.

At 220, the platform may then publish the service data. For example, if the service provider scored above a threshold level or if the service provider was in the top predetermined number of service providers for a specific category or sub-category then the service data may be published.

FIG. 3 is a flow diagram illustrating an example process associated with ranking service providers according to some implementations. In some cases, the platform may limit the number of service providers based on a geographic region and/or based on a category of service. In these cases, the platform may rank or otherwise rate the service providers. The top ranked service provider or the service providers scoring above a threshold may then be published as recommended providers for the geographic region and/or category.

At 302, the platform may receive service provider data associated with a service provider. For example, the platform may receive an invitation for a service provider. The invitation may be initiated by a real estate professional previously registered to the platform, as discussed above, and the service provider data may be provided by the real estate professional and/or the service provider as part of the registration process.

At 304, the platform may assign the service provider to a geographic region and/or one or more service categories. For example, the platform may assign the geographic region based on a location or address associated with the service provider. The platform may assign the service categories based on a list of services selected or otherwise provided by the service provider and/or a list of predetermined service categories.

At 306, the platform may request rating data associated with the service provider from one or more real estate professionals. For example, the platform may request the rating data from registered real estate professionals within the geographic region assigned to the service provider.

At 308, the platform may receive the rating data associated with the service provider. For example, one or more registered real estate professionals may rate or otherwise provide comments, reviews, assessments, and the like associated with the service providers performance on past projects. In some cases, the rating data may include an evaluation, such as a star rating, a score of 1-5, 1-10, etc., a thumbs up or down, and the like.

At 310, the platform may weight the rating data. In one example, the platform may weight the rating data based on information known about the associated real estate professional. For instance, the longer the real estate professional has been licensed, the higher the weight associated with the rating the real estate professional provided may be. In other instances, if the real estate professional had past disciplinary actions the platform may reduce the weighting value applied to that professional's rating data. In other instances, the rating data may be weighted based on interactions or historic data of the real estate professional associated with the platform (e.g., more active users may receive higher weight to their ratings).

At 312, the platform may score the service providers with respect to other service providers based at least in part on the geographic region and/or service category. For example, the platform may rank the service providers based on a score determined with the weighted rating data.

At 314, the platform may determine if the service provider scored above a threshold. The threshold may be a fixed score such as above a 90 out of 100. In other cases, the threshold may be a percentage, such as the top 5% or top 10%. In still other cases, the threshold may be based on a fixed number of service providers. For example, the platform may select a predetermined number of service providers. In some examples, the ranking may be limited to service providers within a geographic region and/or within a service category or sub-category, as discussed above. In some instances, each service provider may have an independent ranking per service category. In this manner, service providers that excel at a particular category of service may be recommend for those service and not for other types or categories.

If the service provider does score above the threshold, the process 300 may advance to 316, and the platform may publish the service data associated with the service provider (e.g., the service provider has been selected for the geographic region and/or at least on service category). However, if the score is less than the threshold, the process 300 may proceed to 318. At 318, the platform may send suggestion to the service provider to assist the service provider with increasing their score or ranking. The scoring process may, in some implementations, be performed on regular intervals, such as weekly, monthly, and the like. In this manner, as additional rating data is received, the recommended service providers may be updated.

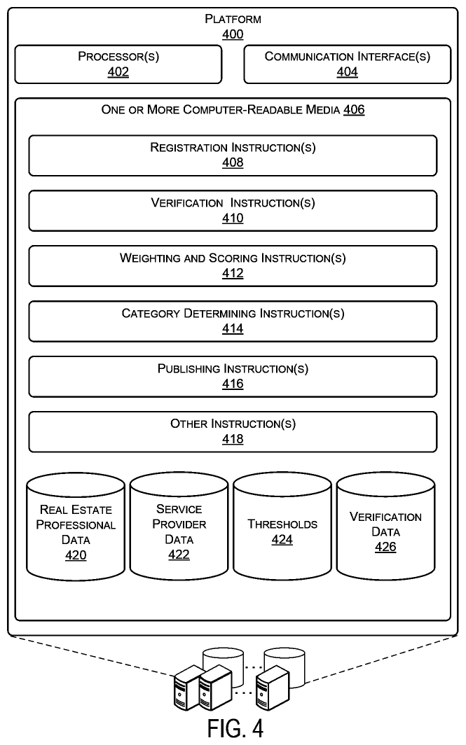

FIG. 4 illustrates an example platform 400 that may implement the various techniques described herein. The platform 400 may be, for example, a server of a service provider, an on-chip system, and/or any other suitable computing device or computing system. The example platform 400 as illustrated includes one or more processors 402, one or more computer-readable media 406, and one or more I/O interfaces 404 that are communicatively coupled, one to another. Although not shown, the platform 400 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The platform 400 is representative of functionality to perform one or more operations using hardware. Accordingly, the platform 400 is illustrated as including hardware elements that may be configured as processors 404, functional blocks, and so forth. This may include implementation in hardware as an application specific integrated circuit or other logic device formed using one or more semiconductors. The hardware elements are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

In the illustrated example, the platform 400 includes one or more communication interfaces 404 configured to facilitate communication between one or more networks, one or more systems (e.g., user and/or third-party devices). The communication interfaces 404 may also facilitate communication between one or more wireless access points, a master device, and/or one or more other computing devices as part of an ad-hoc or local network system. The communication interfaces 404 may support both wired and wireless connections to various networks, such as cellular networks, radio, WiFi networks, short-range or near-field networks (e.g., Bluetooth®), infrared signals, local area networks, wide area networks, the Internet, and so forth.

The computer-readable storage media 406 is illustrated as including memory/storage. The computer-readable storage media 406 may include volatile media (such as random access memory (RAM)) and/or nonvolatile media (such as read only memory (ROM), Flash memory, optical disks, magnetic disks, and so forth). The computer-readable storage media 406 may include fixed media (e.g., RAM, ROM, a fixed hard drive, and so on) as well as removable media (e.g., Flash memory, a removable hard drive, an optical disc, and so forth). The computer-readable media 406 may be configured in a variety of other ways as further described below.

Several modules, such as instructions, data stores, and so forth, may be stored within the computer-readable media 406 and configured to execute on the processors 402. For example, as illustrated, the computer-readable media 406 stores registration instructions 408, verification instructions 410, weighting and scoring instructions 412, category determining instructions 414, publishing instructions 416, as well as other instructions 418, such as an operating system. The computer-readable media 406 may also be configured to store data, such as real estate professional data 420 associated with the real estate professionals having accounts with the platform 400, service provider data 422 associated with the service providers having accounts with the platform 400, thresholds 424 usable to select which of the various service providers to recommend, verification data 426 to assist the platform 400 in verifying the credentials of the real estate professionals.

The registration instructions 408 may be configured to receive a registration request from the real estate professional, service provider, or general user, and to assist the user with registering to the platform 400. For example, the registration instructions 408 may allow a user to populate, organize, and otherwise customize a page or listing associated with the user that may be visible to other users associated with the platform 400.

The verification instructions 410 may be configured to receives the verification data from a real estate professional registering with the platform 400. The verification instructions 410 may verify or otherwise confirm the professional is licensed or credentialed with one or more approved third parties using the verification data 426 and/or data accessible via third-party systems.

The weighting and scoring instructions 412 may be configured to weight rating data associated with a service provider and received from specific real estate professionals. For example, the weighting and scoring instructions 412 may more highly weight negative feedback than positive feedback. In some cases, the weighting and scoring instructions 412 may also weight the rating data based on an interaction level of the associated the real estate professional, demographic data associated with the associated real estate professional, client reviews of the real estate professional accessible via third-party sources, and the like. The weighting and scoring instructions 412 may also be configured to generate a score or rank for each service provider for each category of services that the service provider is associated with or assigned base on, for instance, the rating data.

The category determining instructions 414 may be configured to assign or associate each service provider with one or more service categories. For example, the category determining instructions 414 may assign a service category or sub-category based at least in part on data associated with the service provider received from the real estate professionals and/or the service provider themselves.

The publishing instructions 416 may be configured to publish and/or recommend service providers based at least in part on the score or ranking generated by the weighting and scoring instructions 412. As discussed above, the publishing may be per category of service, per sub-category of service, per geographic region, and/or a combination thereof. In some cases, the publishing instructions 416 may update the published or recommended service providers on periodic basis.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the processors 402. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer. “Computer-readable transmission media” may also refer to a medium that is configured to transmit instructions to the hardware of the computing device 402, such as via a network. Computer-readable transmission media typically may transmit computer-readable instructions, data structures, program modules, or other data in a modulated data signal, such as carrier waves, data signals, or other transport mechanism. Computer-readable transmission media also includes any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, processors 402 and computer-readable media 406 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more processors 402. The platform 400 may be configured to implement particular instructions and/or functions corresponding to the software and/or hardware modules. Accordingly, implementation of a module that is executable by the platform 400 as software may be achieved at least partially in hardware, e.g., through use of computer-readable storage media and/or processors 402 of the platform 400. The instructions and/or functions may be executable/operable by one or more articles of manufacture (for example, one or more platforms 400) to implement techniques, modules, and examples described herein.

The techniques described herein may be supported by various configurations of the platform 400 and are not limited to the specific examples of the techniques described herein. This functionality may also be implemented all or in part through use of a distributed system, such as over a “cloud”, as described below.

The cloud includes and/or is representative of a platform 400. The platform 400 abstracts underlying functionality of hardware (e.g., servers) and software resources of the cloud. The resources may include applications and/or data that can be utilized while computer processing is executed on servers that are remote from the platform 400. Resources can also include services provided over the Internet and/or through a subscriber network, such as a cellular or Wi-Fi network.

The platform 400 may abstract resources and functions to connect the user devices. The platform 400 may also be scalable to provide a corresponding level of scale to encountered demand for the resources that are implemented via the platform 400. Accordingly, in an interconnected device embodiment, implementation of functionality described herein may be distributed throughout multiple devices of the platform 400. For example, the functionality may be implemented in part on the platform 400 which may represent a cloud computing environment.

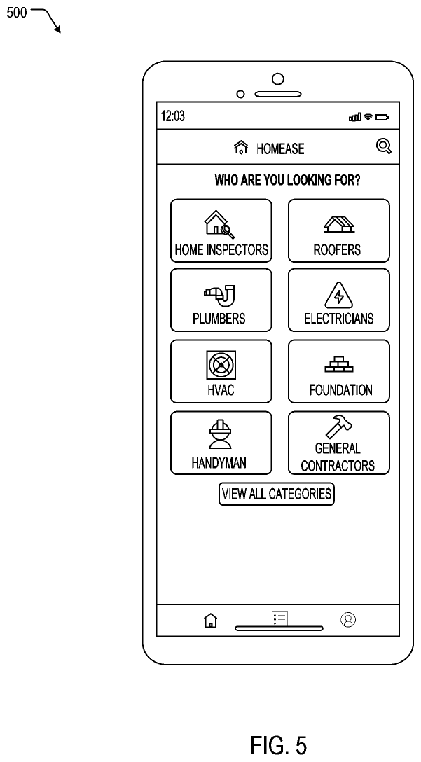

FIG. 5 is an example interface 500 associated with searching for a service provider according to some implementations. In this example, the interface 500 may allow a user to select a type or category of service that the user is interested in. In this example, the platform may initially display the top searched for categories and allow the user to expand or search for additional categories via the selectable options.

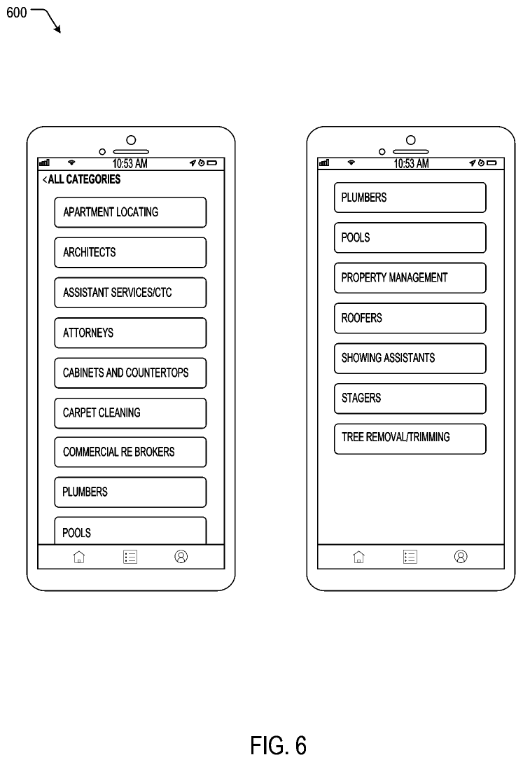

FIG. 6 is another example interface 600 associated with searching for a service provider according to some implementations. In this example, the interface 600 may include a scrollable list of additional service categories that the user may view, such as via an upward or downward swipe along the screen.

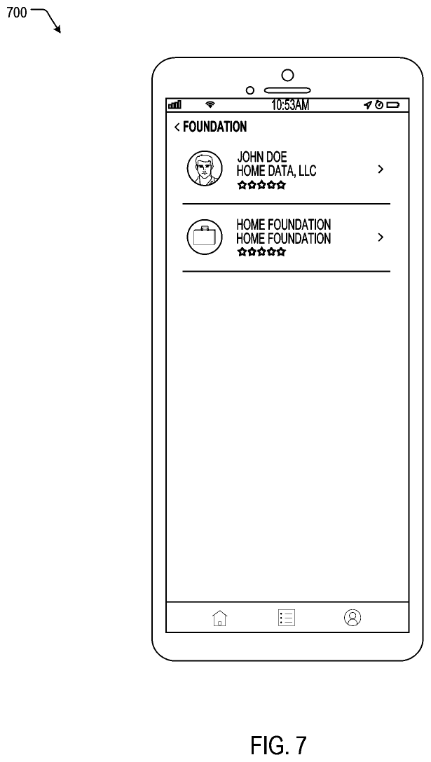

FIG. 7 is an example interface 700 associated with the platform recommending service providers for a particular type of service according to some implementations. In this example, the user may have selected a category from the list of FIG. 5 or 6 and the recommended service providers may be displayed. For instance, as discussed above, the service providers may be ranked or scored, and the top scoring or ranking service providers may be presented with respect to interface 700.

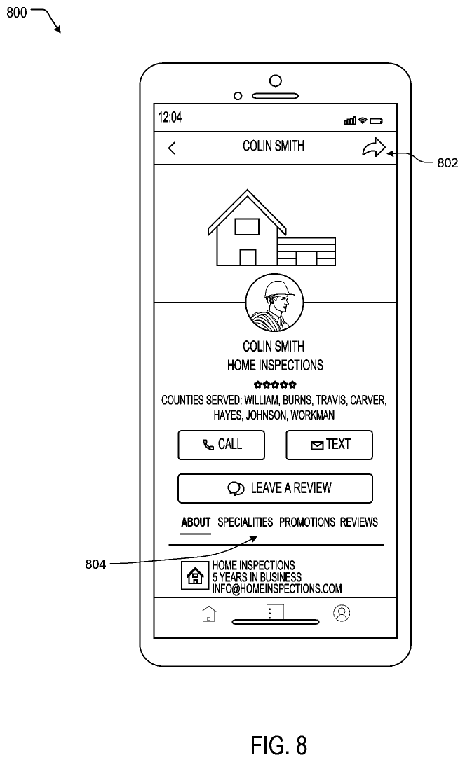

FIG. 8 is an example interface 800 associated with a service provider according to some implementations. In this example, a home page or initial information associated with a service provider may be displayed. For example, in the current interface 800, the user may view a rating (e.g., the star rating), contact information, basic description, or leave a review. In some cases, a user may utilize the share icon 802 to send user data, such as service data of a service provider, to another user. A user may also list a set of specialties or sub-categories that may be displayed upon a selection of the specialties icon 804.

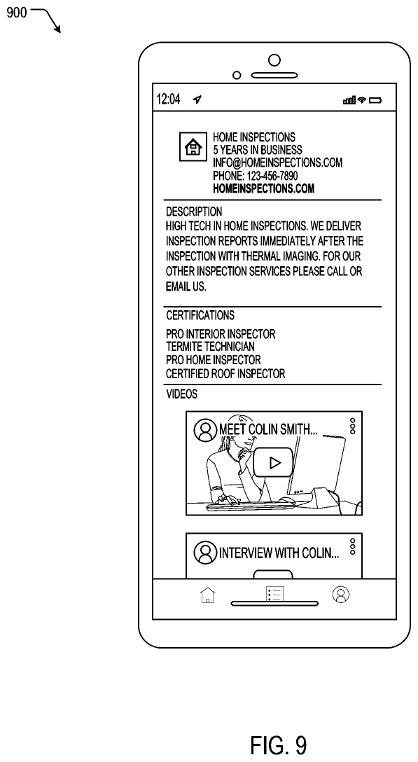

FIG. 9 is another example interface 900 associated with a service provider according to some implementations. In this example, additional information about the service provider may be visible to a user. For example, in the current interface 900, the user may view reviews, more detailed description of services, certification or qualification data, image or videos of past work, and the like.

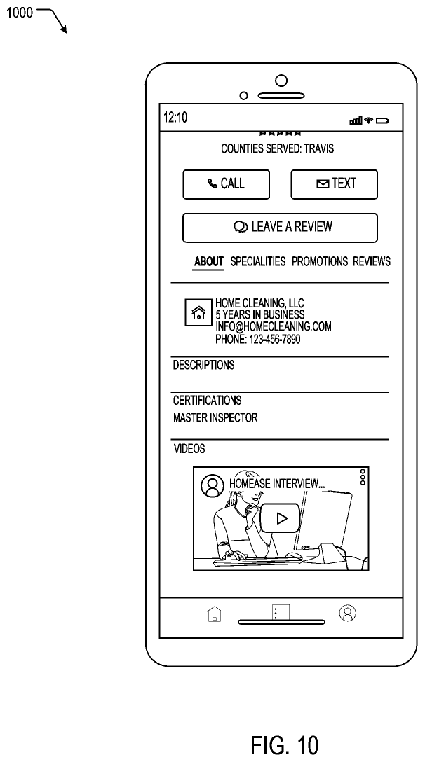

FIG. 10 is another example interface 1000 associated with a service provider according to some implementations. In this example, additional information about the service provider may be visible to a user. For example, in the current interface 1000, the user may view reviews, more detailed description of services, certification or qualification data, image or videos of past work, and the like.

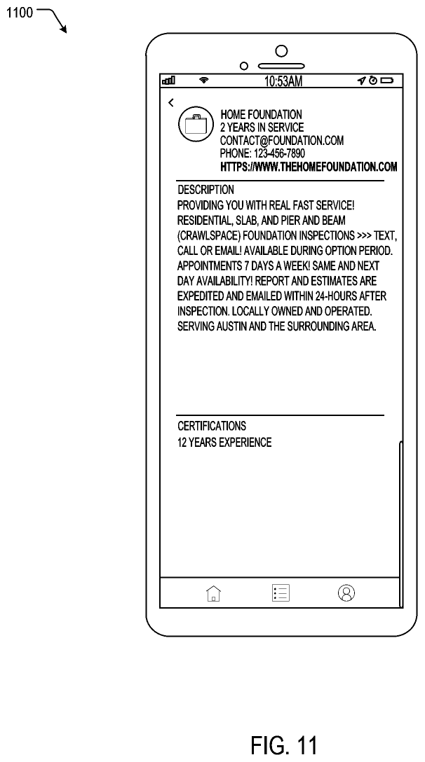

FIG. 11 is another example interface 1100 associated with a service provider according to some implementations. In this example, additional information about the service provider may be visible to a user. For example, in the current interface 1100, the user may view reviews, more detailed description of services, certification or qualification data, image or videos of past work, and the like.

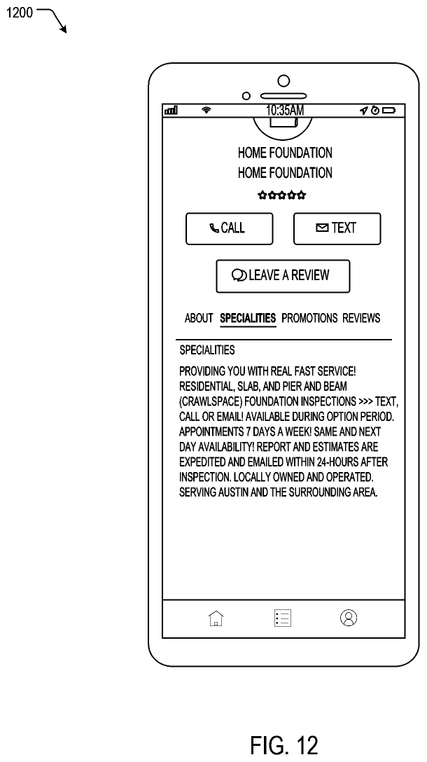

FIG. 12 is another example interface 1200 associated with a service provider according to some implementations. In this example, the interface 1200 may display any information about the specialty services of the service provider, such as sub-categories of services. For example, in the current example, the “home foundation” provider may specialize in “foundation inspections” and the like.

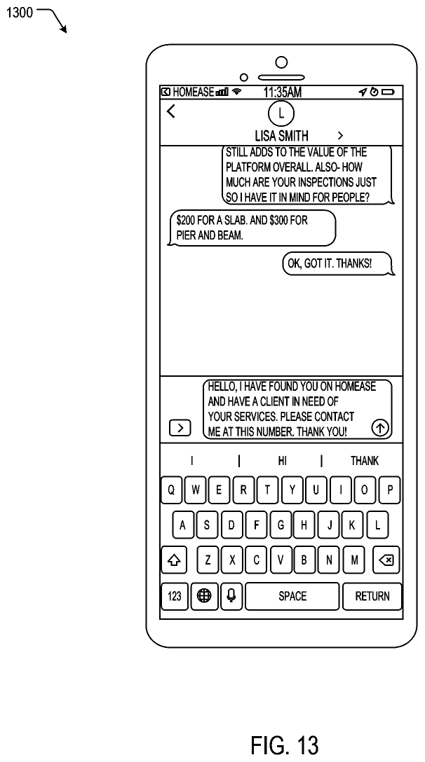

FIG. 13 is an example chat interface 1300 associated with the platform according to some implementations. In the current example, the platform may allow a user to directly connect or discuss services with the service provider, such as via the text-based chat interface 1300.

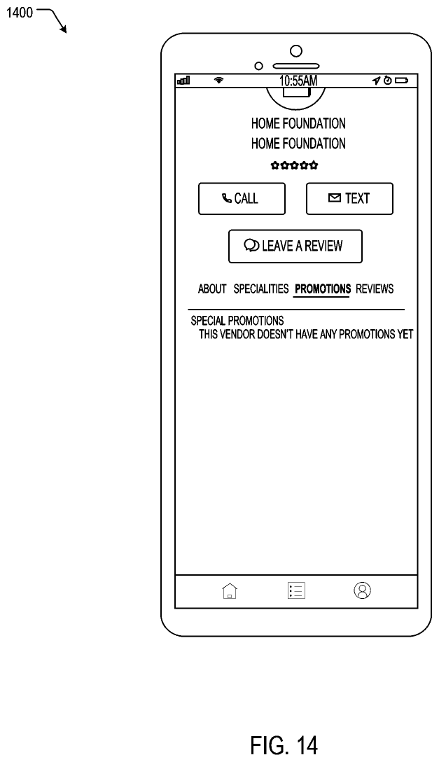

FIG. 14 is an example interface 1400 illustrating promotions associated with a service provider according to some implementations. For example, in some implementations, the platform may allow the service providers to offer promotions and/or transact a purchase on behalf of a user. In these implementations, the platform may allow the service providers to offer promotions via the promotion interface 1400.

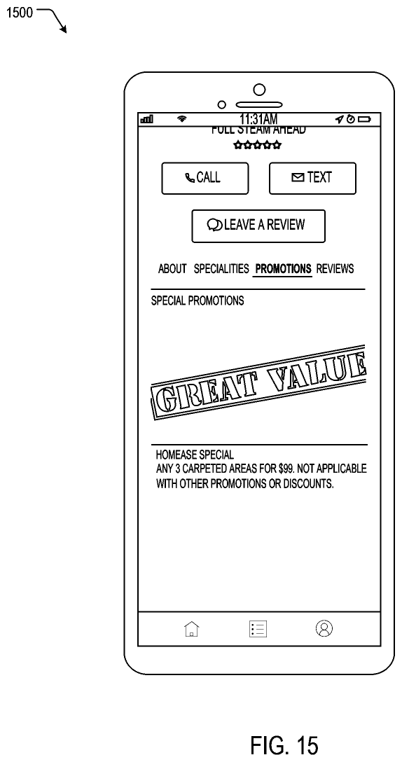

FIG. 15 is another example interface 1500 illustrating promotions associated with a service provider according to some implementations. For instance, in the current example, the service provider has a “great value” promotion that the user may select by, for instance, tapping on the icon.

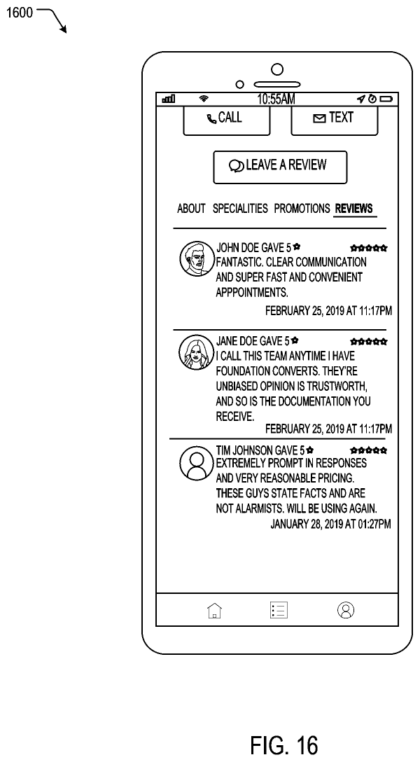

FIG. 16 is an example interface 1600 illustrating reviews associated with a service provider according to some implementations. In some cases, the platform may allow the real estate professionals to post reviews and ratings associated with the service provider. In the current example, the reviews may also include source data indicating an author of the review and a time/date of the review.

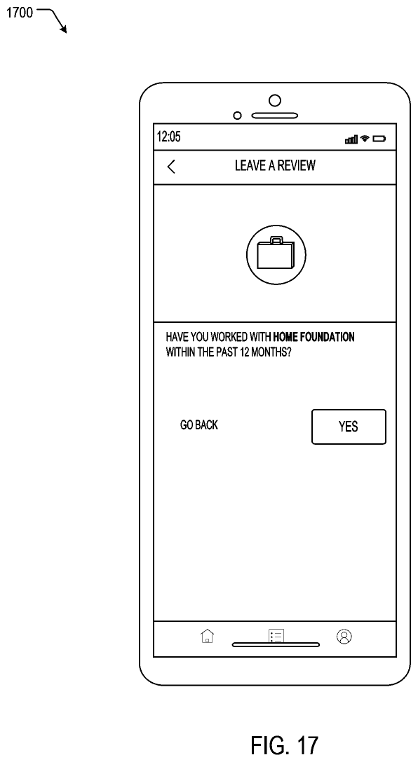

FIG. 17 is an example interface 1700 illustrating capturing rating data or review data associated with a service provider according to some implementations. For example, the platform may request support data associated with the review to assist with weighting and/or validating the rating data and/or review. In the illustrated example, the platform may request that the real estate professional has worked with the service provider within the prior 12 months in order to provide feedback.

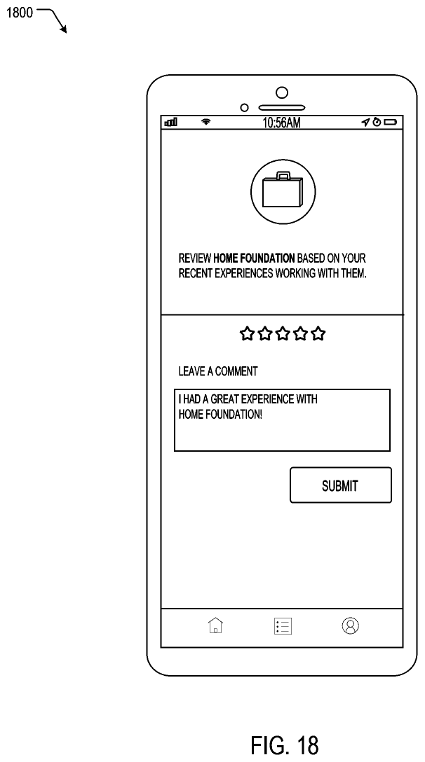

FIG. 18 is another example interface 1800 illustrating capturing rating data or review data associated with a service provider according to some implementations. In this example, the real estate professional may be approved to provide a review or other rating data and input a comment, select a star rating, and the like.

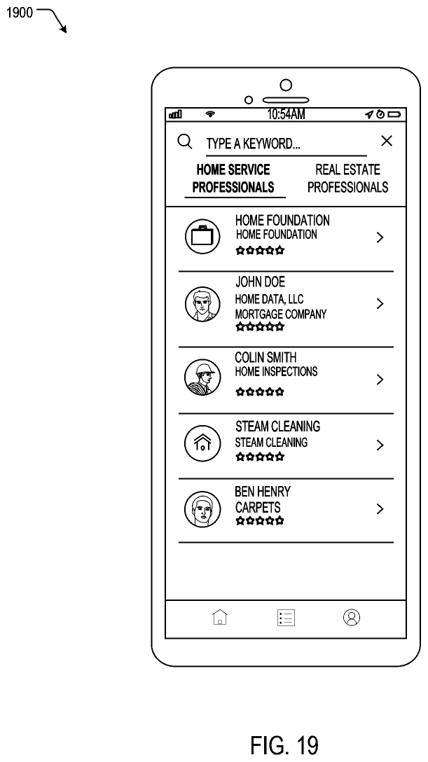

FIG. 19 is another example interface 1900 associated with the platform recommending service providers for a particular type of service according to some implementations. For instance, in the illustrated example, the platform may recommend five service providers for the home service professional categories. In this example, the five service providers may be the top overall service professionals.

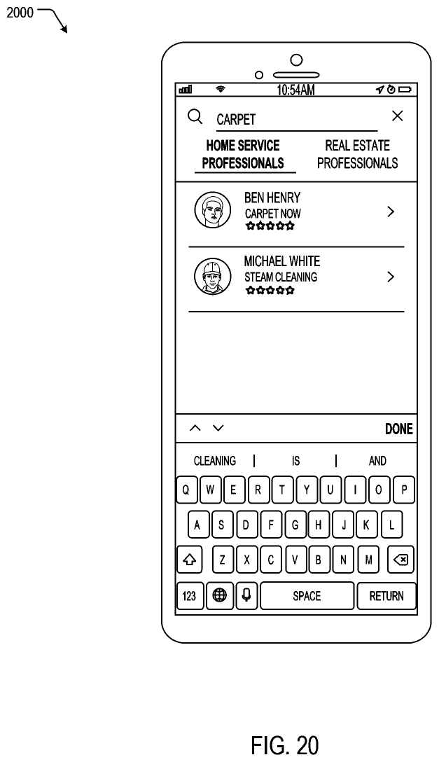

FIG. 20 is another example interface 2000 associated with the platform recommending service providers for a particular type of service according to some implementations. For instance, in the illustrated example, the platform may recommend two service providers for the home carpet category. For instance, only the two illustrated service providers may have scored or ranked high enough to be recommended for the carpet service category.

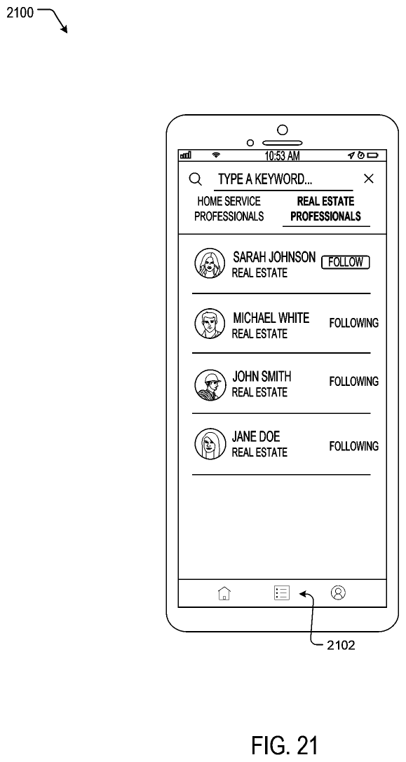

FIG. 21 is another example interface 2100 associated with a list of real estate professionals associated with a service provider according to some implementations. In this example, the real estate professionals may be listed as following or associated with the currently active service provider. In some cases, a user may also share a service provider or real estate professional page with another user via the social feed or page share icon 2102.

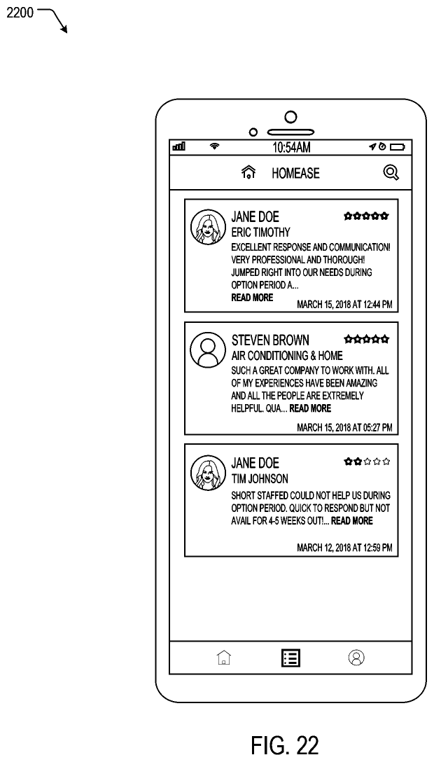

FIG. 22 is another example interface 2200 illustrating review data associated with a service provider according to some implementations. In this example, the user may view the reviews of a particular service provider from various real estate professionals.

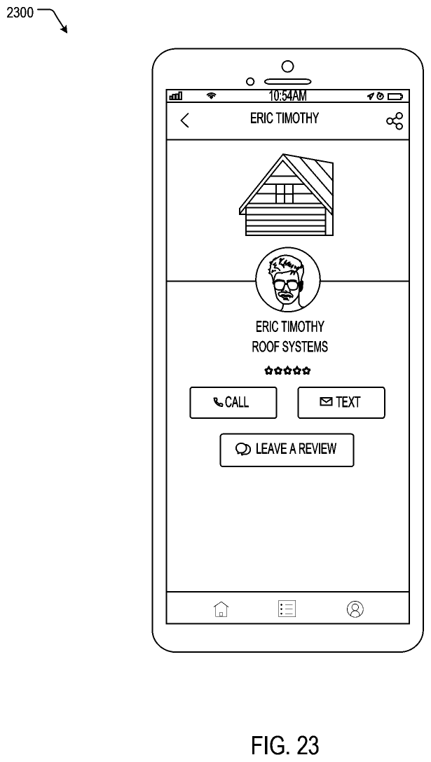

FIG. 23 is another example interface 2300 associated with a service provider according to some implementations. In this example, the service provider may have a home page that allows a viewing user, such as a real estate professional, to leave a review or to get in contact with the service provider. In some cases, the illustrated home page may represent a default home page that may be updated with service provider data from the associated registered service provider.

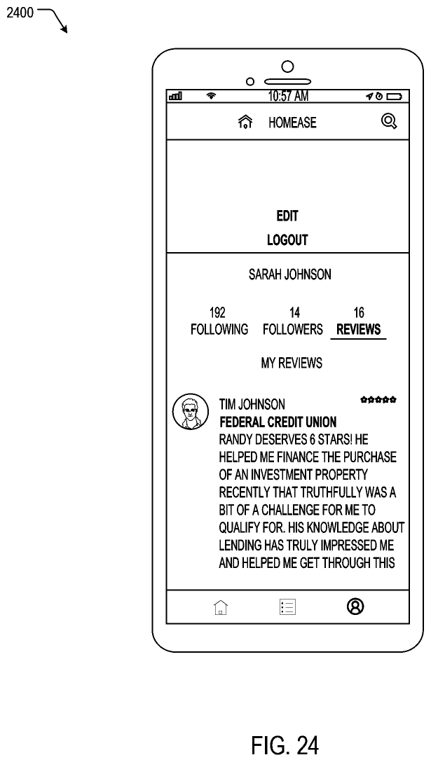

FIG. 24 is another example interface 2400 associated with a service provider according to some implementations. In this example, the user may view the reviews associated with a particular service provider by selecting, for instance, the review icon. Likewise, the user may view the following users and/or the follower users by selecting the corresponding icon.

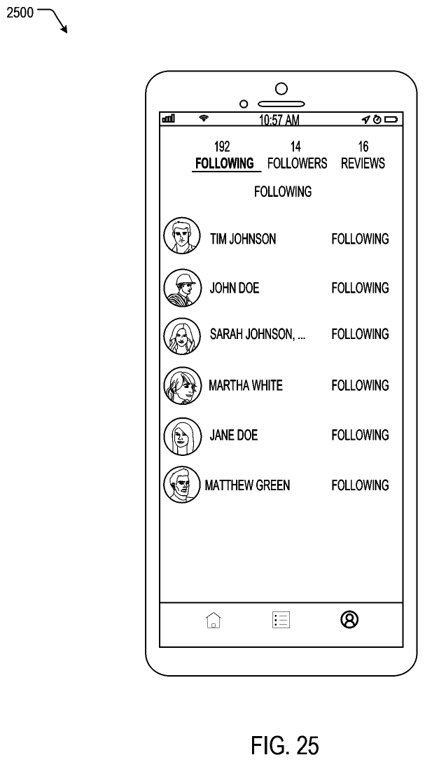

FIG. 25 is another example interface 2500 associated with a service provider according to some implementations. In this example, the user may view the following users associated with a particular service provider by selecting, for instance, the following icon.

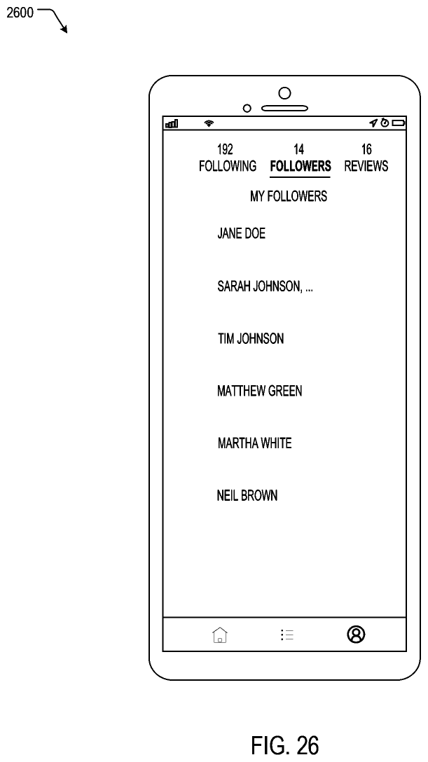

FIG. 26 is another example interface 2600 associated with a service provider according to some implementations. In this example, the user may view the follower users associated with a particular service provider by selecting, for instance, the follower icon.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, at a networking platform, a registration request from a first user, the registration request including validation data associated with a credentialing service;
determining based on the validation data and certification data associated with the credentialing service that the user is a licensed with the credentialing service;
registering the first user with the networking platform as a first class of user;
receiving, at the networking platform and from the first user a request, a request to register a second user;
receiving service data from the second user;
registering the second user with the networking platform as a second class of users based at least in part on the service data;
determining at least one metric associated with users of the second class;
selecting the second user based at least in part on the at least one metric; and
publishing at least a portion of the service data in response to selecting the second user.

2. The method of claim 1, wherein:
registering the second user further comprises determining a first service category associated with the second user; and
determining at least one metric associated with users of the second class further comprises determining the at least one metric for users of the second class associated with the first service category; and
publishing the at least a portion of the service data in response to selecting the second user from the users of the second class associated with the first service category.

3. The method of claim 2, wherein:
registering the second user further comprises determining a first service sub-category associated with the second user, the first service sub-category associated with the first service category; and
determining at least one metric associated with users of the second class further comprises determining the at least one metric for users of the second class associated with the first service sub-category; and
publishing the at least a portion of the service data in response to selecting the second user from the users of the second class associated with the first service sub-category.

4. The method of claim 2, wherein:
registering the second user further comprises determining a second service category associated with the second user; and
determining at least one metric associated with users of the second class further comprises determining the at least one second metric for users of the second class associated with the second service category; and
publishing the at least a portion of the service data in response to selecting the second user from the users of the second class associated with the second service category.

5. The method of claim 1, further comprising accessing the certification data from a third-party database associated with the credentialing service.

6. The method of claim 1, wherein the credentialing service is a board of realtors.

7. The method of claim 1, further comprising:
receiving rating data associated with the second user from a third user, the third user associated with the first class of users; and
wherein determining the at least one metric associated with users of the second class further comprises determining at least one metric associated with the second user based at least in part on the rating data.

8. The method of claim 7, wherein determining the at least one metric associated with the second user based at least in part on the rating data further comprises:
weighting a score associated with the second user based at least in part on a characteristic of the third user.

9. The method of claim 7, wherein the characteristic of the third user is a status associated with the credentialing service.

10. One or more non-transitory computer-readable media storing instructions that, when executed by one or more processors, cause one or more computing devices to perform operations comprising:
receiving a first registration request from a first user, the first registration request including validation data associated with a credentialing service;
determining based on the first validation data and first certification data associated with the credentialing service that the user is a licensed with the credentialing service;
registering the first user with a networking platform, the first user assigned to a first class of user with the networking platform based at least in part on the validation data;
receiving a second registration request from a second user, the second registration request including service data;
registering the second user with the networking platform, the second user assigned to a second class of users in response to determining the second user lacks validation data, the second class;
assigning the second user to a first category based at least in part on the service data;
receiving first rating data associated with the second user from the first user;
selecting the second user based at least in part on the first rating data; and
publishing at least a portion of the service data in response to selecting the second user.

11. The one or more non-transitory computer-readable media as recited in claim 10, wherein the operations further comprise:
determining a score for the second user within the category based at least in part on the rating data; and
wherein selecting the second user is based at least in part on the score meeting or exceeding a threshold.

12. The one or more non-transitory computer-readable media as recited in claim 10, wherein the credentialing service is a board of realtors.

13. The one or more non-transitory computer-readable media as recited in claim 10, the operations further comprising:
receiving second rating data from a third user, the third user of the first class of users; and
wherein selecting the second user is based at least in part on the second rating data.

14. The one or more non-transitory computer-readable media as recited in claim 10, the operations further comprising:
receiving a request from a third user to contact the second user; and
facilitating a communication connection between a device associated with the second user and a device associated with the third user.

15. The one or more non-transitory computer-readable media as recited in claim 10, the operations further comprising:
receiving a request from a third user to complete a transaction for services of the second user; and
processing at least one operation to facilitate the transaction.

16. A computing device comprising:
one or more processors; and
one or more computer-readable media storing instructions that, when executed by the one or more processors, cause the one or more processors to perform operations comprising:
receiving a first registration request from a first user, the first registration request including validation data associated with a credentialing service;
determining based on the first validation data and first certification data associated with the credentialing service that the user is a licensed with the credentialing service; and
registering the first user with a networking platform, the first user assigned to a first class of user with the networking platform based at least in part on the validation data.

17. The system of claim 16, wherein the operations further comprise:
receiving a second registration request from a second user, the second registration request including service data;
registering the second user with the networking platform, the second user assigned to a second class of users in response to determining the second user lacks validation data, the second class;
assigning the second user to a first category based at least in part on the service data;
receiving first rating data associated with the second user from the first user;
selecting the second user based at least in part on the first rating data; and
publishing at least a portion of the service data in response to selecting the second user.

18. The system of claim 17, wherein the operations further comprise:
determining a score for the second user within the category based at least in part on the rating data;
ranking the second user and other users of the second class of users and associated with the first category based at least in prat no the score; and
wherein selecting the second user is based at least in part on the ranking.

19. The system of claim 16, wherein the first category is a predetermined category of services.

20. The system of claim 16, wherein the first user is a real estate professional.
